(19) United States
(12) Patent Application Publication
(10) Pub. No.: US 2018/0258695 A1
(43) Pub. Date: Sep. 13, 2018

(54) SCREEN SYSTEM

(71) Applicants: Jason Earles, Fort McMurray (CA); Eugene Strickland, Fort McMurray (CA)

(72) Inventors: Jason Earles, Fort McMurray (CA); Eugene Strickland, Fort McMurray (CA)

(21) Appl. No.: 15/452,679

(22) Filed: Mar. 7, 2017

(51) Int. Cl. E06B 9/52; E06B 5/00; G09F 23/00; E06B 7/32; F21V 33/00

(52) U.S. Cl. CPC E06B 9/52; E06B 5/003; G09F 23/00; F21Y 2115/10; F21V 33/006; E06B 2009/524; E06B 2009/527; E06B 7/32

(57) ABSTRACT

A screen system includes a screen system having a screen assembly including a screen member with a plurality of equidistantly spaced apertures. The screen member may be mountable to a bottom portion of a door or a window for allowing airflow to pass through the apertures while inhibiting a passage of bugs and insects. The screen member has a sufficient rigidity for preventing damage from at least one pet attempting to pass through the screen member.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of screen inserts and more specifically relates to a screen system.

### 2. Description of Related Art

A screen door may refer to a hinged storm door or hinged screen door covering an exterior door, or a screened sliding door used with sliding glass doors. In any case, the screen door incorporates screen mesh to block flying insects or airborne debris such as seeds or leaves from entering, and pets and small children from exiting interior spaces, while allowing for air, light, and views. Screens are also used to cover the opening of a window. It is usually a mesh made of metal wire, fiberglass, or other synthetic fiber and stretched in a frame of wood or metal. This mesh material may easily tear and does not provide a durable screen for windows and doors. A suitable solution is desired.

U.S. Pat. No. 7,063,374 to Allan Cameron relates to a safety shield window insert. The described safety shield window insert includes a safety device for an automobile. the safety device being a window insert designed to fit within the standard frame of a window and be retrained within the frame by the upper edge of the window insert, along with the window, fitting into the upper channel of the frame of a window and the bottom of the window insert fitting into and being retained by a bracket with the lower edge fitting between the window and the lower inside weather stripping of the window. The window insert can be installed in thirty seconds, requires no modification to the window, frame of a window, or door, and when in place the window may be raised or lowered at any time. The window insert may include orifices to allow air inflow and/or outflow so as to provide a continuous flow of fresh air into the vehicle. The safety device may be used to retain a child or a pet, and can be formed from a plastic, plexiglass, or polycarbonate material. Alternatively, the window insert may be formed from a high impact or bullet proof material.

### BRIEF SUMMARY OF THE INVENTION

In view of the foregoing disadvantages inherent in the known screen inserts art, the present disclosure provides a novel screen system. The general purpose of the present disclosure, which will be described subsequently in greater detail, is to provide a screen system formed from a high impact resistant transparent material. The screen system may be easily installed into a frame of a window or frame of a door of varying sizes.

A screen system is disclosed herein. The screen system includes a screen system comprising a screen assembly including a screen member which may comprise a plurality of equidistantly spaced apertures. The screen member may have a front side, a back side, and a width; the front side and the back side having planar surfaces. The screen member is transparent and may comprise a pet door. The apertures comprise a diameter of approximately 0.0625 inch and are equidistantly spaced a minimum of 0.25 inches from one another. The screen member is formed from a pet proof impact resistant material. The screen member may comprise a substantially rectangular profile and may be mountable to a bottom portion of a door or a window for allowing airflow to pass through the plurality of equidistantly spaced apertures while inhibiting a passage of bugs and insects. The screen member comprises a sufficient rigidity for preventing damage from at least one pet attempting to pass through the screen member.

The invention is directed to an insert formed from a clear or translucent material, adapted to be inserted into, and retained by a frame of a window or a frame of a door. In a preferred embodiment, the screen member is transparent and comprises a clear plastic, plexis glass or other suitable material. The screen system may be easily removed for cleaning and reinstalled.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a screen system, constructed and operative according to the teachings of the present disclosure.

FIG. 1 is a front perspective view of the screen system during an ‘in-use’ condition, according to an embodiment of the disclosure.

FIG. 2 is a front perspective view of the screen system of FIG. 1, according to an embodiment of the present disclosure.

FIG. 3 is a perspective view of the screen system of FIG. 1, according to an embodiment of the present disclosure.

FIG. 4 is a front perspective view of the screen system of FIG. 1, according to an embodiment of the present disclosure.

FIG. 5 is a flow diagram illustrating a method of use for the screen system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a screen inserts and more particularly to a screen system as used to improve the efficiency of use of screens.

Generally, the present invention includes a pet proof plastic or plexis glass screen made of clear plastic, plexis glass or other suitable material. The device may be used on screen doors of varying sizes in campers and homes. The screen system preferably comprises a transparent screen with apertures which allow for airflow. A pet door and led lights may also be included in other embodiments. The screen system may include transparent images for decorative purposes. Screen system may be manufactured in varying sizes to fit screen doors, storm doors, or windows of varying sizes and shapes. Furthermore, screen system solves the problem of pets tearing through and damaging regular mesh screens. The device is removable for ease of cleaning.

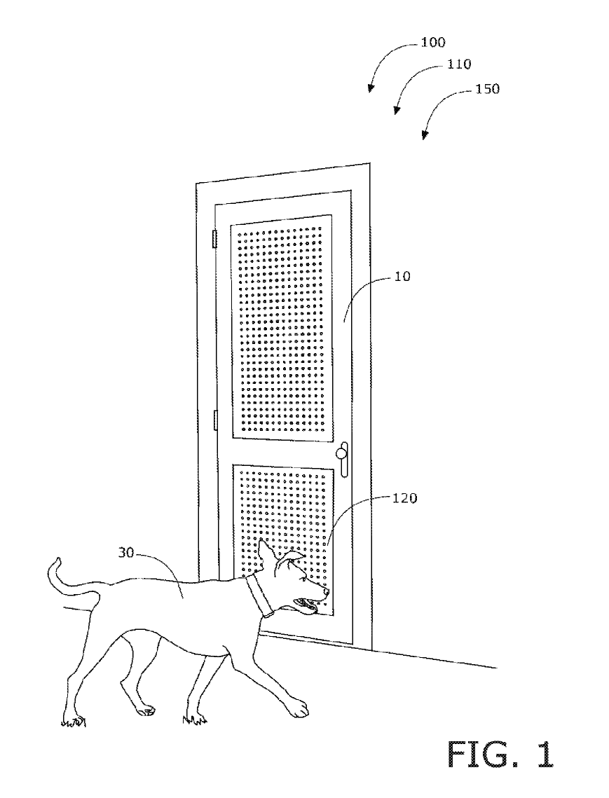

Referring now more specifically to the drawings by numerals of reference, there is shown in FIGS. 1-5, various views of a screen system 100. FIG. 1 shows a screen system 100 during an ‘in-use’ condition 150, according to an embodiment of the present disclosure. As illustrated, the screen system 100 may include a screen assembly 110 including a screen member 120 which may comprise a plurality of equidistantly spaced apertures 124. The screen member 120 may have a front side, a back side, and a width; the front side and the back side having planar surfaces. The screen member 120 may be mountable to a bottom portion of a frame of a door 10 for allowing air to pass through the plurality of equidistantly spaced apertures 124 while inhibiting a passage of bugs and insects. The screen member 120 comprises a sufficient rigidity for preventing damage from at least one pet 30 attempting to pass through the screen member 120.

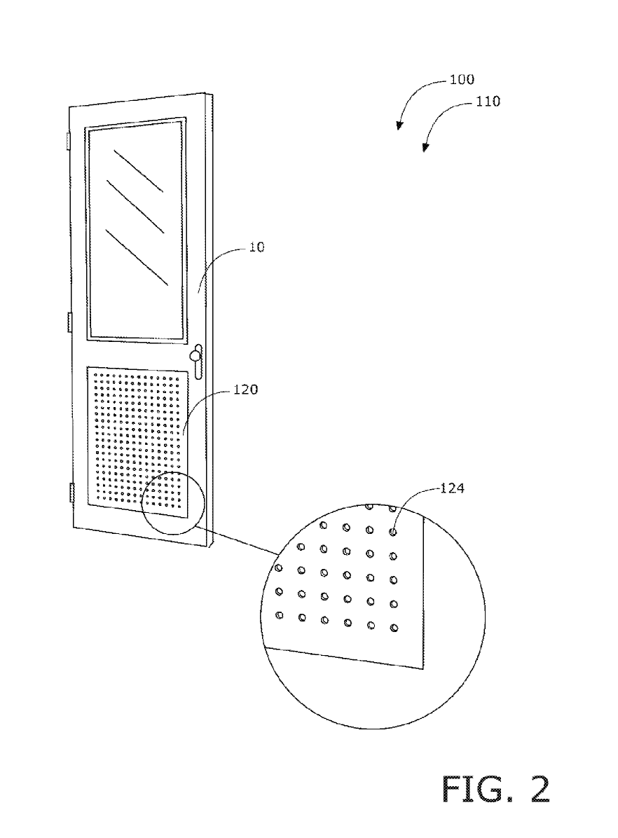

FIG. 2 shows a front perspective view of the screen system 100 of FIG. 1, according to an embodiment of the present disclosure. As above, the screen system 100 may include a screen member 120. The screen member 120 may be rigid or semi-rigid allowing for flexibility as desired. The screen member 120 is removably couplable to a frame of a window or a frame of a door. The invention is directed to an insert formed from a clear or translucent material, adapted to be inserted into, and retained by a frame of a window or a frame of a door. In a preferred embodiment, the screen member 120 is transparent and comprises a clear plastic, plexis glass or other suitable material. The screen member 120 may be easily removed for cleaning and reinstalled.

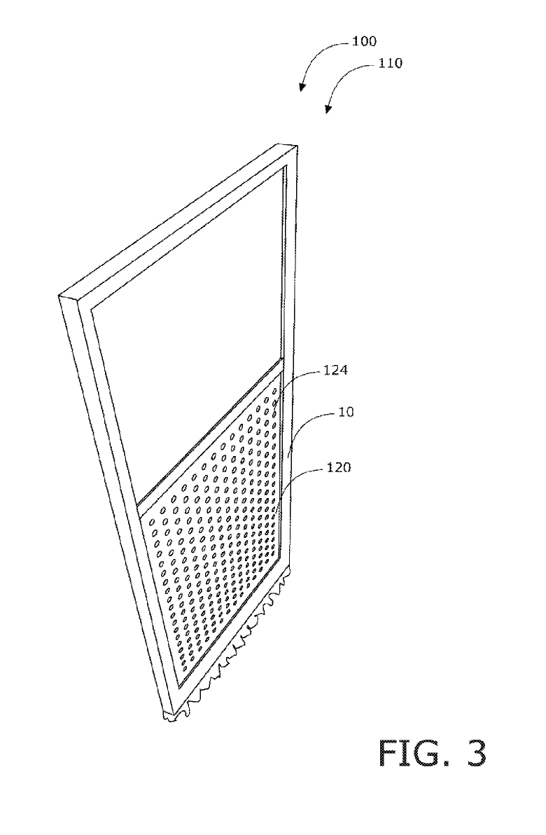

FIG. 3 shows a perspective view of the screen system 100 of FIG. 1, according to an embodiment of the present disclosure. As above, the screen system 100 may include a screen member 120 formed from a pet proof impact resistant material. The pet proof material is selected from a group comprising plexiglass and clear plastic. The screen member 120 comprises a substantially rectangular profile or a square profile configured to be inserted in to a frame of a door 10 and alternatively a frame of a window 20. The device requires no modification to the frame of a window 20, or the frame of a door 10. The screen system 100 insert may include apertures 124 to allow air inflow and/or outflow as to provide a continuous flow of fresh air from outside to the inside environment.

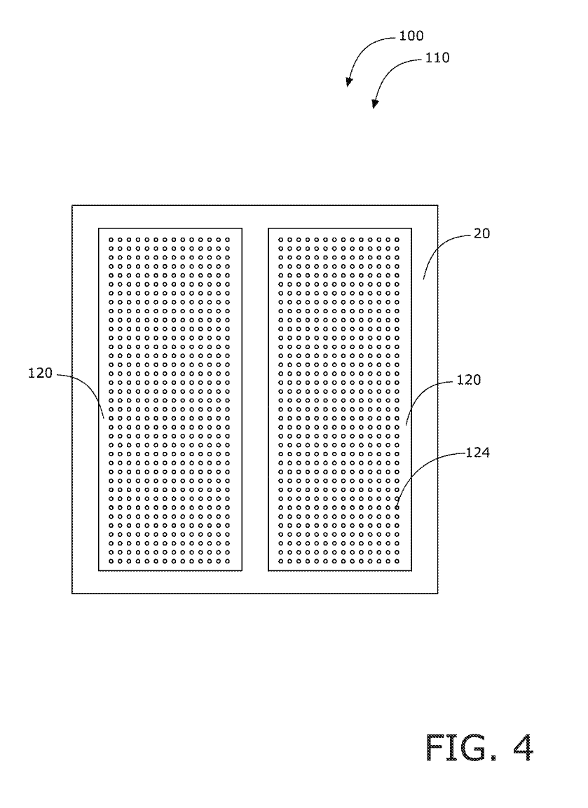

FIG. 4 shows a front perspective view of the screen system 100 of FIG. 1, according to an embodiment of the present disclosure. As above, the screen system 100 may include a screen member 120. The screen member 120 is configured to be mounted to a frame of a window 20 or frame of a door 10 and allow for airflow via a plurality of equidistantly spaced apertures 124. The apertures 124 may comprise a diameter of approximately 0.0625 of an inch and are equidistantly spaced between 0.25 to 0.5 inches from one another. Other sizes are available. The diameter of the aperture 124 allows for air to pass through the screen member 120 while restricting bugs and other pests from entering the screen member 120. The screen member 120 is formed from a high impact resistant transparent material. The screen system 100 is easily installed into a frame of a window 20 or frame of a door 10 of varying sizes.

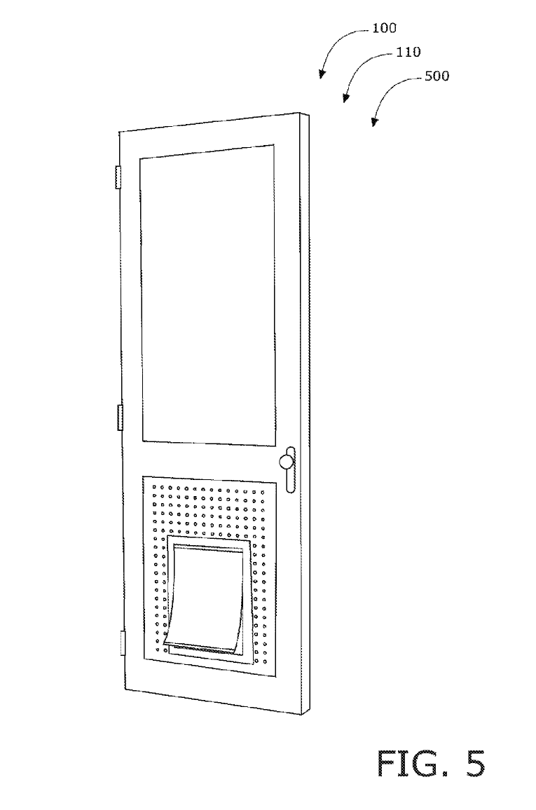

FIG. 5 shows a front perspective view of the screen system 100 of FIG. 1, according to an embodiment of the present disclosure. As above, the screen system 100 may include a screen assembly 110 having a screen member 120. The screen member 120 may include a pet door 126 allowing pets 30 to pass freely through the screen member 120. The present invention may be installed in an existing frame of a window 20 or frame of a door 10 to allow pets 30 to pass through in one or both directions. The screen member 120 may include indicia including transparent images based on user preference. In another embodiment light emitting diode lights may be included. The device is specifically designed for providing a pet-proof screen for a frame of a window 20 or frame of a door 10.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A screen system comprising:
a screen assembly including;
a screen member comprising a plurality of equidistantly spaced apertures, the screen member having a front side, a back side, and a width, and the front side and the back side having planar surfaces;
wherein the screen member is mountable to a bottom portion of a door for allowing airflow to pass through the plurality of equidistantly spaced apertures while inhibiting a passage of bugs and insects; and
wherein the screen member comprises a sufficient rigidity for preventing damage from at least one pet attempting to pass through the screen member.

2. The screen system of claim 1, wherein the screen member is semi-rigid.

3. The screen system of claim 1, wherein the screen member is rigid.

4. The screen system of claim 1, wherein the screen member is transparent.

5. The screen system of claim 1, wherein the screen member comprises a pet door.

6. The screen system of claim 1, wherein the screen member comprises indicia.

7. The screen system of claim 6, wherein the indicia comprises a transparent image.

8. The screen system of claim 1, wherein the screen member comprises light emitting diode lights.

9. The screen system of claim 1, wherein the screen member is configured to be mounted to a frame of a window.

10. The screen system of claim 1, wherein the apertures comprise a diameter of approximately 0.0625 inch.

11. The screen system of claim 10, wherein the apertures are equidistantly spaced a minimum of 0.25 inches from one another.

12. The screen system of claim 11, wherein the apertures are equidistantly spaced a maximum of 0.5 inches from one another.

13. The screen system of claim 1, wherein the screen member is formed from a pet proof impact resistant material.

14. The screen system of claim 13, wherein the pet proof material is selected from a group comprising plexiglass and clear plastic.

15. The screen system of claim 1, wherein the screen member comprises a substantially rectangular profile.

16. The screen system of claim 1, wherein the screen member comprises a square profile configured to be inserted in to a door and alternatively a frame of a window.

17. A screen assembly, the screen assembly comprising:
a screen assembly including;
a screen member comprising a plurality of equidistantly spaced apertures, the screen member having a front side, a back side, and a width, and the front side and the back side having planar surfaces;
wherein the screen member is mountable to a bottom portion of a door for allowing airflow to pass through the plurality of equidistantly spaced apertures while inhibiting a passage of bugs and insects;
wherein the screen member is transparent;
wherein the screen member comprises a pet door;
wherein the apertures comprise a diameter of approximately 0.0625 inch;
wherein the apertures are equidistantly spaced a minimum of 0.25 inches from one another;
wherein the screen member is formed from a pet proof impact resistant material;
wherein the pet proof material comprises clear plastic;
wherein the screen member comprises a substantially rectangular profile; and
wherein the screen member comprises a sufficient rigidity for preventing damage from at least one pet attempting to pass through the screen member.
